(19) United States
(12) Patent Application Publication
(10) Pub. No.: US 2025/0148722 A1
(43) Pub. Date: May 8, 2025

(54) SYSTEMS AND METHODS FOR GENERATING AN INTERACTIVE 3D ENVIRONMENT USING SPATIAL COMPUTING FOR VALIDATION OF DATA

(71) Applicant: BANK OF AMERICA CORPORATION, Charlotte, NC (US)

(72) Inventors: Chetan Singh Naruka, Gurugram (IN); Suresh P. Jolhapuram, Mumbai (IN); Abirami V B, Tiruchirappalli (IN); Shailendra Singh, Thane West (IN)

(73) Assignee: BANK OF AMERICA CORPORATION, Charlotte, NC (US)

(21) Appl. No.: 18/504,851

(22) Filed: Nov. 8, 2023

(51) Int. Cl. G06T 19/00

(52) U.S. Cl. CPC G06T 19/00; G06T 2200/24

(57) ABSTRACT

Systems, computer program products, and methods are described herein for generating an interactive 3D environment using spatial computing for validation of data. The present invention is configured to identify a user account(s), wherein the one user account(s) is associated with a resource account(s); identify a historical resource transmission(s) based on the resource account(s), wherein the historical resource transmission(s) is associated with geolocation coordinate(s) or an entity identifier(s); generate a virtual computing environment based on the historical resource transmission(s) and the geolocation coordinate(s) or the entity identifier(s); and generate a virtual computing environment alert interface component(s), wherein the virtual computing environment alert interface component(s) comprises a validation indicator(s) associated with each historical resource transmission of the historical resource transmission(s), and wherein the virtual computing environment alert interface component(s) is overlayed in the virtual computing environment.

### FIELD OF THE INVENTION

The present invention embraces a system for generating an interactive 3D environment using spatial computing for validation of data.

### BACKGROUND

In today's world, where visual data and digital multimedia has taken over the presentation of information to users across the world, there exists a great need to present non-uniform data in a clear, concise, and easy-to-use manner, whereby a user can quickly and easily validate whether the data presented is accurate. This problem is especially exacerbated when a user has difficulties remembering real-world locations that the user may have visited which is associated with certain data that needs to be presented and validated by the user. Similarly, the problem is additionally intensified when false data is difficult to identify based on data identifiers alone. Thus, there exists a need for a system that can efficiently, accurately, and dynamically generate and present a 3D environment to a user to show data as alert interface components that can mimic the data in a virtual environment.

Applicant has identified a number of deficiencies and problems associated with validating data, especially historical events. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for generating an interactive 3D environment using spatial computing for validation of data is provided. In some embodiments, the system may comprise: a memory device with computer-readable program code stored thereon; at least one processing device, wherein executing the computer-readable code is configured to cause the at least one processing device to perform the following operations: identify at least one user account, wherein the at least one user account is associated with at least one resource account; identify at least one historical resource transmission based on the at least one resource account, wherein the at least one historical resource transmission is associated with at least one geolocation coordinate or at least one entity identifier; generate a virtual computing environment based on the at least one historical resource transmission and at least one of the geolocation coordinate or the at least one entity identifier; and generate at least one virtual computing environment alert interface component, wherein the at least one virtual computing environment alert interface component comprises at least one validation indicator associated with each historical resource transmission of the at least one historical resource transmission, and wherein the at least one virtual computing environment alert interface component is overlayed in the virtual computing environment.

In some embodiments, executing the computer-readable code is configured to cause the at least one processing device to perform the following operations: identify whether the at least one validation indicator comprises a positive input; generate, based on the identification that the at least one validation indicator comprises the positive input, a warning alert interface component; and overlay the warning alert interface component on the virtual computing environment at a virtual location associated with the geolocation coordinate or the entity identifier. In some embodiments, the at least one validation indicator comprising the positive input comprises a dispute claim input in the virtual computing environment. In some embodiments, the warning alert interface component comprises a real-time value at the virtual location.

In some embodiments, executing the computer-readable code is configured to cause the at least one processing device to perform the following operations: generate a virtual computing environment avatar based on the user amount, the at least one historical resource transmission; and dynamically update the virtual computing environment avatar based on the at least one historical resource transmission at each of the at least one geolocation coordinate or the at least one entity identifier. In some embodiments, the virtual computing environment avatar is dynamically updated based on at least one positive indicator associated with the at least one geolocation coordinate or the at least one entity identifier.

In some embodiments, executing the computer-readable code is configured to cause the at least one processing device to perform the following operations: generate at least one planning interface component associated with the virtual computing environment, wherein the at least one planning interface component is overlayed in the virtual computing environment based on the at least one geolocation coordinate or the at least one entity identifier; identify at least one planning interface component input at the virtual computing environment, wherein the at least one planning interface component input is associated with a sequence log for the associated the at least one geolocation coordinate or the at least one entity identifier; and generate, based on the at least one planning interface component input, a planning indication associated with the at least one geolocation coordinate or the at least one entity identifier.

In some embodiments, the virtual computing environment is generated based on a large video map model (LVMM), and wherein the LVMM is pre-trained on a plurality of videos, a plurality of images, a plurality of visual effects, a plurality geographical coordinates, and a plurality of images or videos associated with each geographical coordinate of the plurality of geographical coordinates.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for generating an interactive 3D environment using spatial computing for validation of data, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for generating an interactive 3D environment using spatial computing for validation of data, in accordance with an embodiment of the disclosure;

FIG. 4 illustrates a process flow for generating and overlaying a warning alert interface component, in accordance with an embodiment of the disclosure;

FIG. 5 illustrates a process flow for generating and dynamically updating a virtual computing environment avatar based on historical resource transmission(s), in accordance with an embodiment of the disclosure;

FIG. 6 illustrates a process flow for generating a planning indication, in accordance with an embodiment of the disclosure;

FIG. 7 illustrates an exemplary virtual computing environment, in accordance with an embodiment of the disclosure;

FIG. 8 illustrates an exemplary virtual computing environment avatars, in accordance with an embodiment of the disclosure; and

FIG. 9 illustrates an exemplary virtual computing environment based on geolocation coordinates or entity identifiers and comprising virtual computing environment alert interface components, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored and retrieved electronically using a computing device.

As used herein, a “resource transfer,” “resource transmission,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transmission,” “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

In today's world, where visual data and digital multimedia has taken over the presentation of information to users across the world, there exists a great need to present non-uniform data in a clear, concise, and easy-to-use manner, whereby a user can quickly and easily validate whether the data presented is accurate. This problem is especially exacerbated when a user has difficulties remembering real-world locations that the user may have visited which is associated with certain data that needs to be presented and validated by the user. Similarly, the problem is additionally intensified when false data is difficult to identify based on data identifiers alone. Thus, there exists a need for a system that can efficiently, accurately, and dynamically generate and present a 3D environment to a user to show data as alert interface components that can mimic the data in a virtual environment.

The disclosure provides herein a system that leverages spatial computing to overlay a virtual world environment and virtual world components onto a real world view (such as through a virtual reality (VR) headset and/or the like, where a user may wear the VR headset as they move through the real world), whereby the digital components are associated with past resource transmissions (e.g., past financial transactions, other such data transmissions, and/or the like) at particular real world locations (such as brick and mortar locations). Further, the disclosure may provide for a generative movie transformer which leverages an AI model, an auto avatar generator, and cloud services to generate a virtual movie for the user based on the historical resource transmissions such that the user can validate the data of the resource transmissions to determine if they are true or fake.

By way of example, the system is configured to allow for a user of a VR headset to view their past resource transmissions as a virtual reality movie so that the user can view their historical resource transmissions. Additionally, and in some embodiments, where the data is determined to be fake, a validation indicator for the system to generate an alert that fake data (e.g., a fake resource transmission) has been identified.

Accordingly, the present disclosure provides for identifying at least one user account, wherein the at least one user account is associated with at least one resource account; identifying at least one historical resource transmission based on the at least one resource account, wherein the at least one historical resource transmission is associated with at least one geolocation coordinate or at least one entity identifier; and generating a virtual computing environment based on the at least one historical resource transmission and at least one of the geolocation coordinate or the at least one entity identifier. Further, the disclosure provides for generating at least one virtual computing environment alert interface component, wherein the at least one virtual computing environment alert interface component comprises at least one validation indicator associated with each historical resource transmission of the at least one historical resource transmission, and wherein the at least one virtual computing environment alert interface component is overlayed in the virtual computing environment.

What is more, the present invention provides a technical solution to a technical problem. As described herein, the technical problem includes the determining and validating data using a virtual electronic environment and virtual computing environment alert interface component(s). The technical solution presented herein allows for a system, method, and/or apparatus configured to generate a virtual computing environment and virtual computing environment alert interface components comprising validation indicator(s) associated with the historical resource transmission(s) and other such data. In particular, the disclosure provided herein is an improvement over existing solutions to the determination and validation of electronic data, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

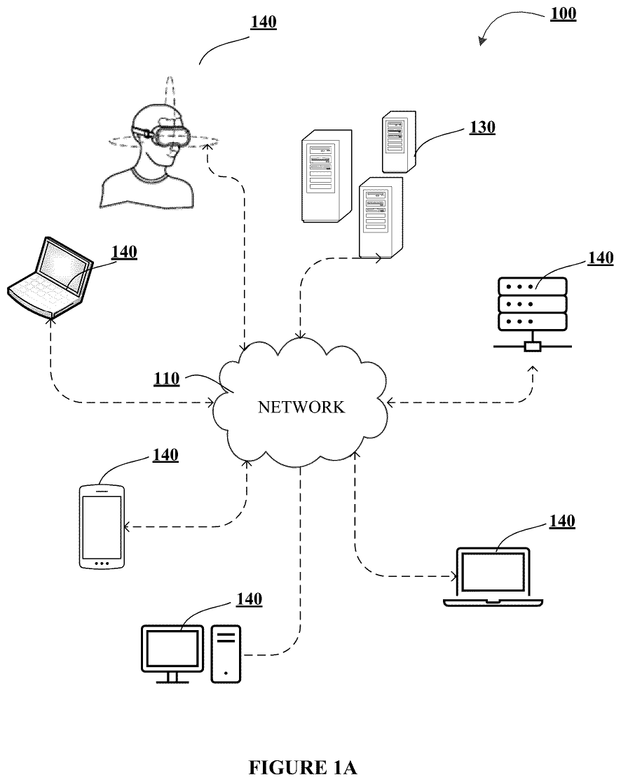

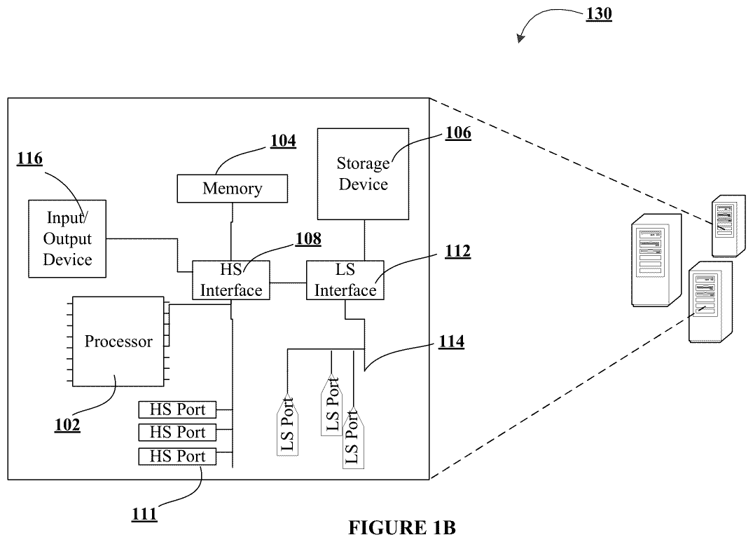

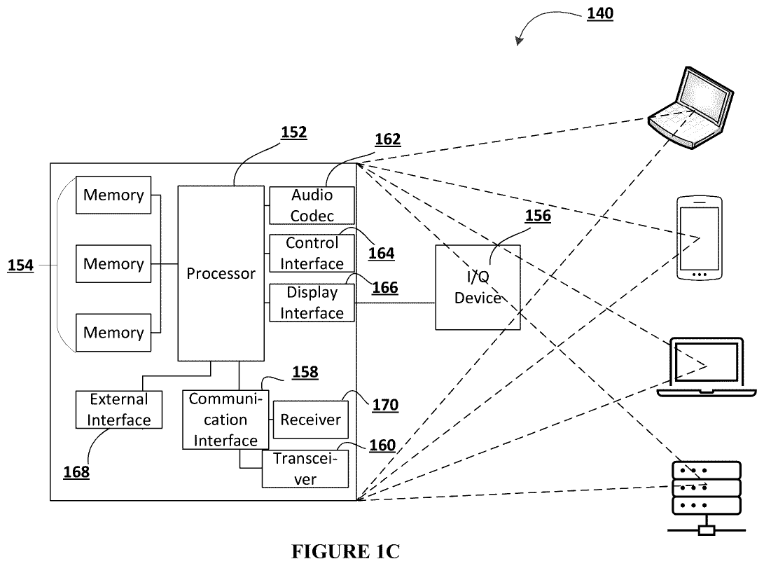

FIGS. 1A-1C illustrate technical components of an exemplary distributed computing environment generating an interactive 3D environment using spatial computing for validation of data 100, in accordance with an embodiment of the invention. As shown in FIG. 1A, the distributed computing environment 100 contemplated herein may include a system 130 (i.e., an system configured for generating an interactive 3D environment using spatial computing to validate data), an end-point device(s) 140 (e.g., which may comprise a virtual reality (VR) headset, an augmented reality (AR) headset, and/or the like), and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

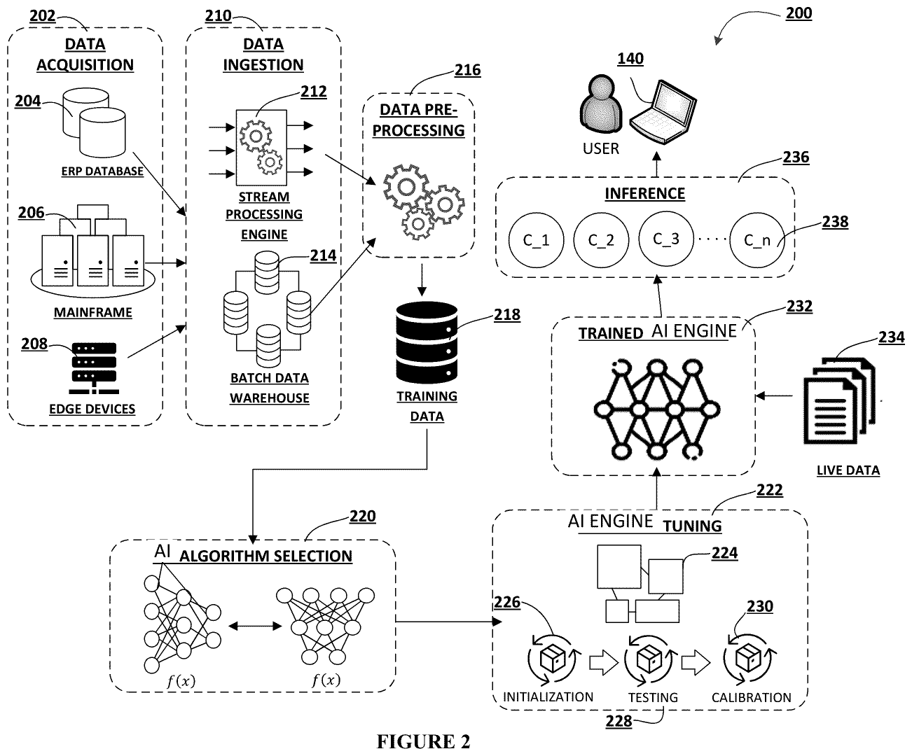

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

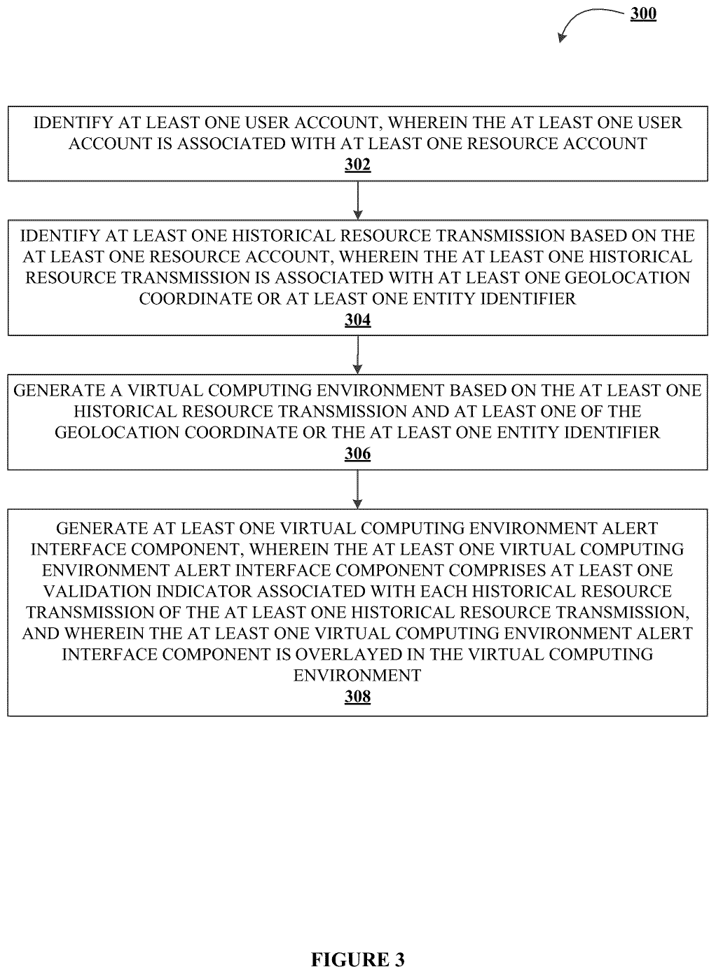

FIG. 3 illustrates a process flow 300 for generating an interactive 3D environment using spatial computing for validation of data, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of identifying at least one user account, wherein the at least one user account is associated with at least one resource account.

In some embodiments, the user account may be identified by identifying a historical resource transmission report which may comprise data (e.g., resource transmission amount(s), resource transmission locations and/or identifiers, and/or the like), by identifying a user account from a database, by identifying a user account from the user associated with user account opting into the service provided by the system (e.g., generating a resource transmission movie and/or generating a virtual computing environment for the user to interact with as they review their historical resource transmissions), and/or the like. In some embodiments, the user account may be identified based on a resource transmission period occurring (e.g., every two weeks, every three weeks, every month, and/or the like) which may additionally and/or alternatively be used to generate the historical resource transmission record.

In some embodiments, and based on the identification of the user account, at least one resource account associated with the user account may be identified. In this manner, and similar to the description provided above, a resource account may comprise data regarding the historical resource transmissions that have occurred from and/or to the at least one resource account. For example, and each time a merchant transaction occurs by the user account, that user account may track the merchant transaction based on what resource account it comes from and/or goes to, and may track the underlying data of those historical resource transmission (e.g., a geolocation coordinate for the merchant, an entity identifier for the merchant, the historical resource transmission amount, the timestamp the historical resource transmission was initiated, the timestamp the historical resource transmission was completed, and/or the like).

As shown in block 304, the process flow 300 may include the step of identifying at least one historical resource transmission based on the at least one resource account, wherein the at least one historical resource transmission is associated with at least one geolocation coordinate or at least on entity identifier.

In some embodiments, and for example, the historical resource transmission(s) may be identified based on parsing data in a resource account, parsing data in a resource transmission report, parsing data in a resource account based on a resource transmission period, and/or the like. In some embodiments, the at least one historical resource transmission identified may be associated with at least one geolocation coordinate and/or entity identifier (e.g., which may be used to identify the merchant where the historical resource transmission occurred and/or was initiated). For instance, at least one geolocation coordinate may be associated with each historical resource transmission identified, whereby-and in some embodiments-one geolocation coordinate may be shared with a plurality of historical resource transmission (such as where a user of the user account visited the same geolocation and/or entity multiple times). In some embodiments, the geolocation coordinate(s) and/or entity identifier(s) may be used to identify the location of the resource transmission's origination, such as a brick and mortar location, like a merchant's store, a restaurant, a service-provider, a gas station, a convenience store, and/or the like.

In some embodiments, the historical resource transmission(s) may be associated with at least one entity identifier, whereby the entity identifier may be generated by the system itself, by the entity itself (e.g., by the merchant and may comprise a store locator identifier such as a numeric identifier and alphabetic identifier, and/or the like, which may be used to identify individual locations from a chain of merchants), by a client of the system, and/or the like. As used herein, the entity identifier refers to a unique string of alphanumeric characters used to uniquely identify the entity and the location of the entity from other entities at other locations.

In some embodiments, the historical resource transmissions identified and/or used may be based on a historical resource transmission period (e.g., the last two weeks, the last month, a predefined billing period, a predefined reporting period, and/or the like). In some embodiments, such a historical resource transmission period may be based on a client's determination of the historical resource transmission period (e.g., the period for resource transmission reports such as financial statement reports, which may comprise a bi-weekly period, a month period, and/or the like). In some embodiments, the resource transmission period may be determined by the system itself (e.g., based on the number of resource transmissions), based on the locations of the resource transmissions (e.g., only the resource transmissions associated with the same city, county, state, and/or the like), and/or the like.

As shown in block 306, the process flow 300 may include the step of generating a virtual computing environment based on the at least one historical resource transmission and at least one of the geolocation coordinate or the at least one entity identifier. As used herein, the term virtual computing environment refers to a virtual reality environment which may be shown in a virtual reality headset (VR headset), an augmented reality headset (AR headset), a spatial computing device, and/or the like. The virtual reality environment may comprise a virtual computing environment that is overlayed over a real-world environment (such as a real-world view through the goggles a VR headset, an AR headset, and/or the like), such that virtual environment component(s) are shown over the real-world view.

In some embodiments, the real-world view may be copied and displayed in the virtual computing environment along with the virtual environment components overlayed on the copied real-world view. In this manner, a viewer using the virtual reality headset would be unable or unlikely to differentiate the real-world environment shown in the virtual reality headset from the actual real-world view if the viewer were physically at the location of the real-world location (e.g., actually at a merchant location associated with the historical resource transmission).

In some embodiments, the geolocation coordinate(s) and/or entity identifier(s) from the historical resource transmission data is what determines the virtual computing environment and its associated views. In this manner, the system may be configured to render the virtual computing environment to mirror the real-world view of the geolocation coordinate and/or entity identifier such that the viewer can view the digital rendering of the merchant location where the user previously shopped and which matches the user's historical resource transmissions.

In some embodiments, the virtual computing environment is generated by a spatial computing component or device. Such a spatial computing component may comprise an Internet of Things (IoT) component or device, ambient computing or device, augmented reality, virtual reality, artificial intelligence, and/or physical controls. As used herein, the spatial computing component is configured to incorporate real-world experiences, views, objects, and/or the like into an augmented reality, mixed reality or virtual reality environment, such that the real-world experiences, views, objects, and/or the like, are referenced in the augmented reality, mixed reality or virtual reality environment. In this manner, the user of the system which uses the spatial computing component can interact with the digital content of the virtual reality environment, which may comprise digital renderings of the views, objects, and/or the like of the real-world environment. Additionally, and in some embodiments, the system (in combination with the spatial computing component) may generate digital components and/or interface components that will be displayed within the virtual computing environment in order to show data to the user regarding their historical resource transmissions. In some embodiments, these digital components and/or interface components may additionally be configured to accept user inputs from the user device as the user is interacting with the virtual computing environment.

In some embodiments, the virtual computing environment is generated based on a large video map model (LVMM), and wherein the LVMM is pre-trained on a plurality of videos, a plurality of images, a plurality of visual effects, a plurality geographical coordinates, and a plurality of images or videos associated with each geographical coordinate of the plurality of geographical coordinates. Such a LVMM may be used by the system to generate resource transmission movie, which may be used to show the user of the user account their historical resource transmissions in a frame-by-frame narrative, which may additionally comprise the virtual computing environment such that the user may interact within the digital environment as the historical resource transmission data is shown. In some such embodiments, the resource transmission movie may show the virtual computing environment comprising digital renderings of the brick and mortar locations visited by the user in the real-world to complete the historical resource transmissions, and such a resource transmission movie may further comprise digital components and/or interface components showcasing data regarding each of the historical resource transmissions as the resource transmission movie progresses.

As used herein, the large video map model (LVMM) comprises a machine learning model and/or AI engine whereby at least one of the machine learning model and/or the AI engine are trained to generate embedded images for each frame of a resource transmission movie based on the data of the resource transmissions for each user account. Such embedded images may be further configured by the LVMM as the “best image” to showcase the view of the real-world environment in the resource transmission movie. As used herein, the term “best image” for purposes of the resource transmission movie may mean at least one of and/or a combination of a most clear view of the real-world environment structure (e.g., such as the most clear view of the front of a real-world environment structure, such as a merchant's storefront including their logo and/or the like), the most uninterrupted view of the real-world structure (e.g., such that the view of the merchant's storefront is uninterrupted by other structures, cars, garbage trucks, and/or the like), a view comprising the greatest number of pixels allowed for the resource transmission movie showcasing the real-world structure in the resource transmission movie, and/or the like.

In some embodiments, the resource transmission movie may comprise the “best positions” for viewing. For instance, and in some embodiments, the LVMM may be configured to determine the “best position” for a virtual computing environment avatar to “stand” to view the digital renderings of the real-world environment without the user's view being interrupted, to see the digital renderings as clear as possible (e.g., see the digital rendering of a store front as clear as possible), and/or the like.

In some embodiments, the LVMM is pre-trained on a plurality of videos, a plurality of images, a plurality of visual effects, a plurality of geographical coordinates, and a plurality of images or videos associated with each geographical coordinate of the plurality of geographical coordinates. For instance, and in some embodiments, the LVMM may be pre-trained on data regarding previous resource transmission movies (i.e., previous resource transmission movies), including but not limited to the images used showcasing the real-world structures (e.g., the images used to showcase brick-and-mortar locations), the previous resource transmissions used to generate the previous resource transmission movies, visual effects used in the previous resource transmission movies (e.g., the visual effects as the virtual computing environment avatar progresses through the resource transmission movie), the map coordinates associated with the geolocation identifier(s) and/or entity identifier(s) of the previous resource transmissions and how those are used to generate the previous resource transmission movies frame-by-frame, images and/or videos collected to showcase each geolocation identifier(s) and/or entity identifier(s), and the images and/or videos used to generate the previous resource transmission movies. In this manner, and by way of example, the LVMM may be trained using previous data and previous examples in the previous resource transmission movies to generate the current resource transmission movies.

In some embodiments, the LVMM may additionally be trained by a feedback loop, such that a user (such as a user associated with the user account) may input their feedback for how the resource transmission movie is generated (e.g., its format, its views, its images, its avatar(s), and/or the like). Such feedback may be used to train the LVMM in real-time and/or near real-time. Such feedback may additionally be used to train the LVMM for the particular user account, but also—in some embodiments—for all the users of the system as general feedback.

In some embodiments, the LVMM consolidates a plurality of related images into at least one frame associated with the at least one geolocation coordinate, and where a plurality of frames are merged to generate a resource transmission movie. For example, and in some embodiments, the LVMM may consolidate, merge, and/or combine a plurality of related images into at least one frame of the plurality of frames used to generate the resource transmission movie(s). In this manner, the LVMM may take a plurality of images (such as from a search engine) associated with at least one geolocation coordinate and/or entity identifier, and may combine some or all the images into at least one frame showcasing at least one view associated with the geolocation coordinate and/or the entity identifier (e.g., a merchant's location) to generate the resource transmission movie. Such a frame may be used to generate the virtual computing environment that may be interacted with by the user using their virtual computing environment avatar, such that each of frames generated by the plurality of related images may be used to generate the virtual computing environment showcasing the real-world environment in the digital world as accurately as possible.

In some embodiments, the resource transmission movie comprises a digital component showing each resource transmission amount for each location, and/or an overall resource transmission amount for each location over the resource transmission period. For example, and in some embodiments, the digital component discussed above may show each historical resource transmission amount (e.g., the individual resource transmission amount(s) identified in block 302) for each geolocation coordinate (e.g., within the resource transmission movie) as the user walks through the real-world environment, and/or the overall historical resource transmission amount (e.g., the total historical resource transmission amount for each geolocation coordinate and/or entity identifier) over the historical resource transmission period (e.g., the past two weeks, the past month, and/or the like). Additionally, and/or alternatively, the digital component may show the number of visits that occurred at the real-world location by the user of the user account, time spent at the location (e.g., individually per visit and/or overall), total amount of historical resource transmissions that have occurred from the resource account associated with the user account, and/or the like.

As shown in block 308, the process flow 300 may include the step of generating at least one virtual computing environment alert interface component, wherein the at least one virtual computing environment alert interface component comprises at least one validation indicator associated with each historical resource transmission of the at least one historical resource transmission, and wherein the at least one virtual computing environment alert interface component is overlayed in the virtual computing environment. As used herein, the virtual computing environment alert interface component comprises a data packet of data regarding the historical resource transmission that occurred at the geolocation identifier and/or entity identifier showcased in the virtual environment. In some embodiments, the data packet may further comprise a validation indicator which may an comprise data requesting the user validate the historical resource transmission or decline the validation of the historical resource transmission (e.g., indicate the historical resource transmission is false).

By way of example, the virtual computing environment alert interface component and its associated data may be transmitted to a user device and may be used to configure the graphical user interface (GUI) of the user device to show the user the data in a human-readable format. In some embodiments, and where the user device is a VR headset and/or an AR headset, the system may transmit the virtual computing environment alert interface component to the VR headset and/or the AR headset in order to configure the view of the user's headset to show the data in the virtual computing environment and/or—in some embodiments—the resource transmission movie.

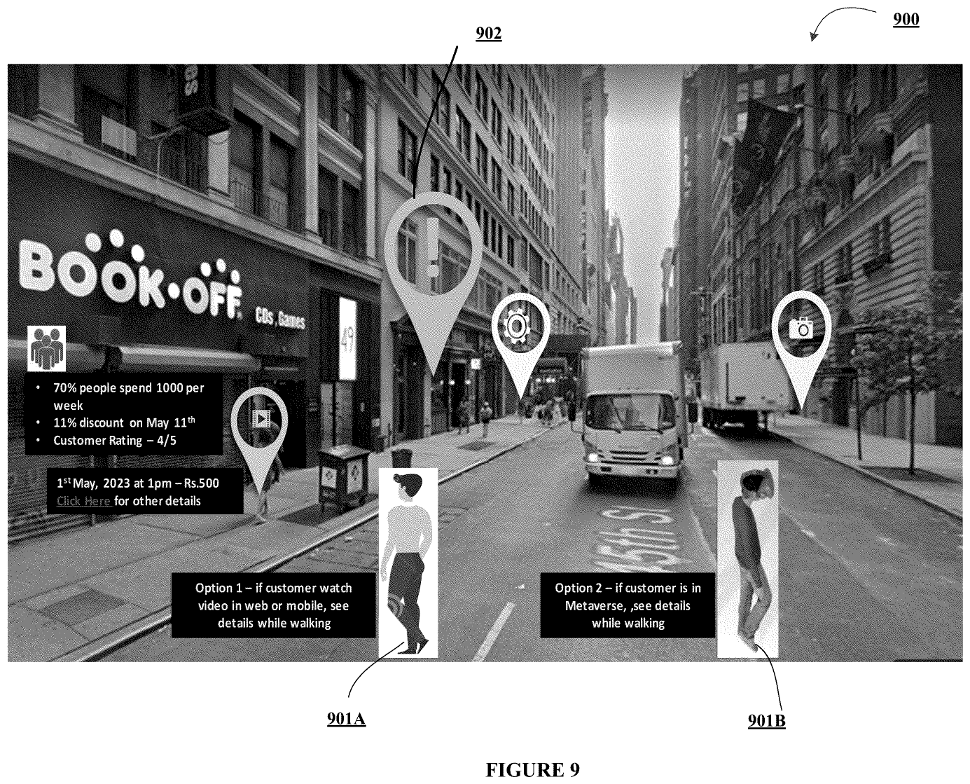

As used herein, the overlaying of the virtual computing environment alert interface component in the virtual computing environment comprises a superimposed view of the data of the virtual computing environment alert interface component in the virtual computing environment, such that the data of the virtual computing environment alert interface component is shown in a particular location associated with the geolocation coordinate and/or entity identifier without completely blocking the user's view of the digital rendering and/or real-world rendering (e.g., in the case of a mixed reality and/or AR headset where the digital components are overlayed on a real-world view) of the merchant's location. Such an example of the superimposed view of the virtual computing environment alert interface component in the virtual computing environment is shown and described below with respect to FIG. 9.

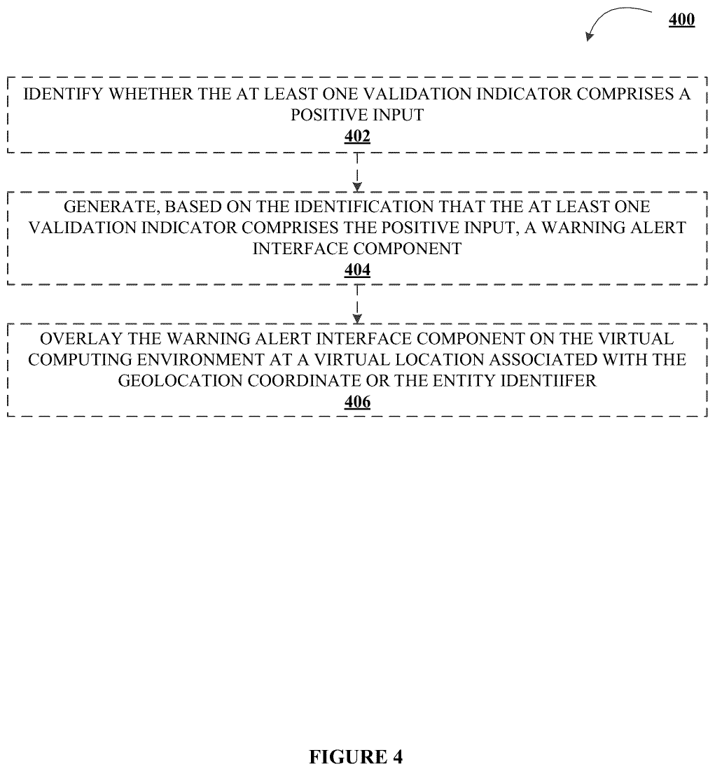

FIG. 4 illustrates a process flow 400 for generating and overlaying a warning alert interface component, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process flow 400. In some embodiments, an artificial intelligence engine (e.g., such as the AI engine shown in FIG. 2) may perform some or all of the steps of process flow 4000.

In some embodiments, and as shown in block 402, the process flow 400 may include the step of identifying whether the at least one validation indicator comprises a positive input. As used herein, such a positive input may comprise an indication that the at least one historical resource transmission associated with the positive input identified and/or received is false. For example, and upon generating and transmitting the virtual computing environment alert interface component to a user device (which comprises a validation indicator), the user of the user device may input a negative input or a positive input in response to the validation indicator. As used herein, the positive input may be identified based on the user interacting with the virtual computing environment and its digital component(s) shown to the user (e.g., whereby the digital component(s) may comprise a digital component requesting an input from the user for the validation indicator regarding each historical resource transmission as they are shown) and the positive input may be used as a feedback to identify to the system the historical resource transmissions that are false. In contrast, a negative input (which may be received and/or identified in the same manner as that described hereinabove for the positive input) may be used as a feedback to identify to the system that the historical resource transmission is true and accurate (e.g., did actually occur by the user, was initiated by the user, was intended by the user, and/or the like).

In some embodiments, the absence of any input by the user for the validation indicator may be understood by the system as a negative input. For instance, such a lack of response or feedback by the user, may be understood by the system to mean that the user has no problem with the historical resource transmission identified. In some embodiments, such as pre-understanding by the system may be predefined by a client of the system (e.g., a financial institution associated with the resource account at issue), a manager of the system, a user of the system (e.g., the user associated with the resource account), and/or the like.

In some embodiments, the at least one validation indicator comprising the positive input comprises a dispute claim input in the virtual computing environment. For example, and in some embodiments, the dispute claim input may comprise an input by the user in the virtual computing environment, whereby the dispute input claim input may further comprise data such as a timestamp of the historical resource transmission identified with the positive input for the dispute claim, the entity identifier and/or geolocation identifier, the resource transmission amount, and/or the like. In some embodiments, the data of the historical resource transmission may comprise data regarding whether any other dispute input claims have been input for the same entity identifier.

In some embodiments, such a dispute claim input and its associated data may be identified at the user device based on the reception and identification of the positive input for the validation indicator, whereby the dispute claim input comprises a request for the user that input the positive input to add any other information and/or data before transmitting the data of the false historical resource transmission to an entity for resolving. In some embodiments, such a transmission of the false historical resource transmission may be transmitted over a network from the system (e.g., such as after collecting the necessary data for the historical resource transmission) to a client of the system (e.g., such as the financial institution associated with the resource account at issue).

In some embodiments, and as shown in block 404, the process flow 400 may include the step of generating—based on the identification that the at least one validation indicator comprises the positive input—a warning alert interface component. For example, such a warning alert interface component may comprise a data packet that is generated by the system to show that the historical resource transmission should not have occurred (e.g., is false, and/or the like), and may be transmitted to a user device and used to configure the graphical user interface of the user device to show the data of the warning alert interface component. In this manner, a user of the user device may view the data of the warning alert interface component (e.g., the historical resource transmission amount, the entity identifier for the historical resource transmission, the timestamp of the historical resource transmission, and/or the like).

In some embodiments, the user device that may receive the warning alert interface component may comprise a user device associated with a client of the system (such as an information technology (IT) specialist of the client), a user device associated with a manager of the system, a user device associated with the user account (e.g., a personal computer associated with the user of the user account, a VR headset owned and/or operated by the user of the user account, an AR headset owned and/or operated by the user of the user account, and/or the like), and/or the like. In some embodiments, the warning alert interface component may be transmitted to a plurality of user devices, such as a user device associated with the client of the system (such as a financial institution's user device, whereby the financial institution may operate the resource account associated with the historical resource transmission) and a user device associated with the user of the user account for the historical resource transmission.

In some embodiments, the warning alert interface component comprises a real-time value at the virtual location. For instance, and in some embodiments, the warning alert interface component may comprise a real-time value, whereby the real-time value may be associated with a real-time value of all the positive indicators received for false resource transmissions (e.g., whereby each positive indicator is counted as one instance and each instance is counted to generate the real-time value). In some embodiments, the real-time value may be associated with a total number of all the historical resource transmissions associated with a positive indicator for false resource transmissions (e.g., each amount for each historical resource transmission determined to be false may be counted to determine the real-time value). Thus, and in some embodiments, the real-time value may be shown using a digital component and/or interface component such that the real-time value is displayed in the virtual computing environment to the user as the user interacts within the virtual computing environment. In some embodiments, such a real-time value digital component and/or interface component may be used to forewarn the user from visiting the real-world location associated with a high number of real-time values in the virtual computing environment.

In some embodiments, and as shown in block 406, the process flow 400 may include the step of overlaying the warning alert interface component on the virtual computing environment at a virtual location associated with the geolocation coordinate or the entity identifier. For example, and in some embodiments, the system may overlay (e.g., by superimposing the warning alert interface component in same manner as that descried above with respect to the virtual computing environment alert interface component) the warning alert interface component on the virtual computing environment such that the data of the warning alert interface component is shown in the virtual computing environment in the same and/or similar location as the virtual location of the merchant where the historical resource transmission occurred. In this manner, the warning alert interface component may comprise the data of the false historical resource transmission (e.g., the amount of the historical resource transmission; the timestamp(s) of the historical resource transmission, such as the initiation timestamp and/or the completion timestamp; the entity identifier and/or geolocation coordinate; and/or the like) in a human-readable format and may be used to show to the user of the user the data of the false historical resource transmission.

In some embodiments, the warning alert interface component may additionally and/or alternatively show the data of other false historical resource transmission (e.g., the number of false historical resource transmissions at each entity and/or geolocation/virtual location, the timestamps for each of the false historical resource transmissions, the timestamp for the most recently identified false historical resource transmission, and/or the like). In some such embodiments, the system may redact and/or take out any personally identifiable information regarding each of these false historical resource transmissions, such that the personal information for each of the users that submitted the positive input at the validation indicator remain private and secure. In such embodiments, a user may view the warning alert interface component without having to have previously input a positive input for the virtual location and instead may use the warning alert interface component to determine which merchants and/or locations may be visited (e.g., those with little to no false historical resource transmissions) and those to avoid (e.g., those with a high number of false historical resource transmissions).

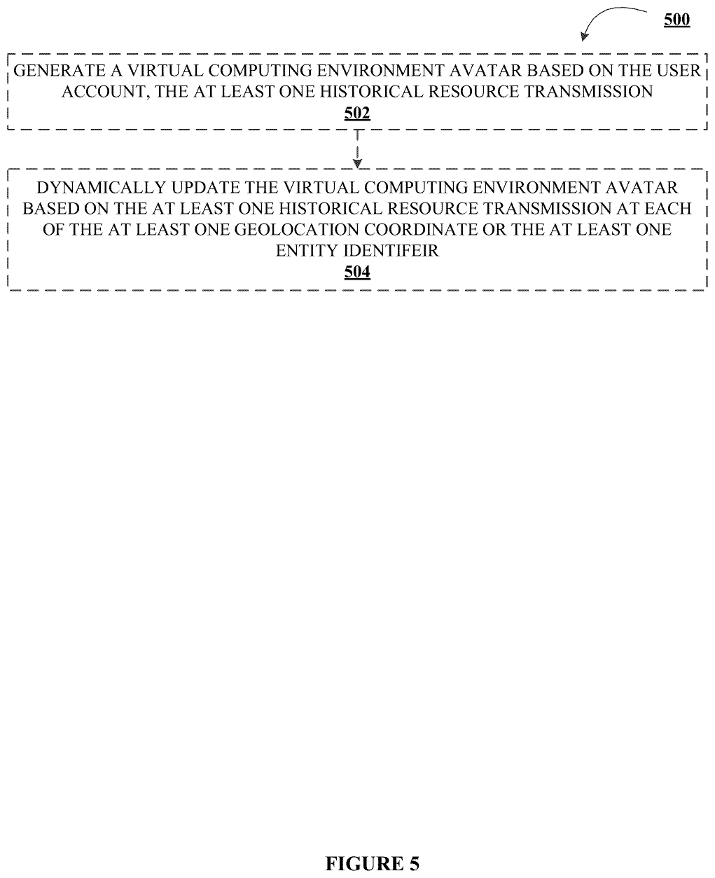

FIG. 5 illustrates a process flow 500 for generating and dynamically updating a virtual computing environment avatar based on historical resource transmission(s), in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process flow 500. In some embodiments, an artificial intelligence engine (e.g., such as the AI engine shown in FIG. 2) may perform some or all of the steps of process flow 500.

In some embodiments, and as shown in block 502, the process flow 500 may include the step of generating a virtual computing environment avatar based on the user account, the at least one historical resource transmission. For example, such a virtual computing environment avatar may be generated in the virtual computing environment as a digital rendering of the user associated with the user account. In this manner, the virtual computing environment avatar may appear similar to the user (e.g., with similar physical characteristics, and/or the like). In some embodiments, however, the user of the user account may generate the virtual computing environment avatar with whatever characteristics they may choose such that the virtual computing environment avatar appears as the user intends. For example, the user of the user account may input at least one avatar parameter(s) (e.g., the appearance of the avatar may be based on inputs received from the user account after the user of the user account has selected the parameters, such as the hair color of the avatar, the outfit of the avatar, the shoes of the avatar, and/or the like).

In some embodiments, the virtual computing environment avatar is dynamically updated based on at least one positive indicator associated with the at least one geolocation coordinate or the at least one entity identifier. For example, and in some embodiments, the virtual computing environment avatar may be dynamically updated based on at least one historical resource transmission, such that based on the at least one historical resource transmission the avatar's appearance and/or metadata may change. For instance, and as the virtual computing environment avatar “moves” between virtual geolocations and/or between virtual entities associated with the at least one geolocation and/or the entity identifier associated with the historical resource transmission(s), the avatar's appearance may change based on the resource transmission(s) that occurred at each merchant location (e.g., the greater the resource transmissions, the larger the virtual computing environment avatar will appear).

In some embodiments, the dynamic change(s) may be based on just one resource transmission and/or a plurality of historical resource transmissions for the geolocation coordinate and/or entity identifier (e.g., the virtual computing environment avatar may get larger the greater number of historical resource transmissions and/or the greater combination of historical resource transmissions, the clothing of the virtual computing environment avatar may change, the features of the virtual computing environment avatar may change, and/or the like).

In some embodiments, the dynamic updating of the virtual computing environment avatar may be based on the at least one positive indicator (e.g., such as the positive input at the validation indicator) which may indicate that the historical resource transmission is false. Thus, and by way of example, the physical characteristics of the virtual computing environment avatar may change dynamically (e.g., may get bigger, taller, and/or wider) at virtual locations associated with a plurality of positive indicators (e.g., which may indicate that a certain location and/or entity is likely to have a lot of false historical resource transmissions in its history). In some embodiments, the virtual computing environment avatar's clothes may change dynamically based on the presence of at least one positive indicator associated with the virtual location (e.g., virtual computing environment avatar's shirt, pants, and/or whole outfit may change to red), such the change in characteristics will be readily noticeable to the user. In this manner, the user of the user device viewing the virtual computing environment will easily notice when a virtual location may be associated with false resource transmissions in their history and should be avoided and/or looked at more closely if any historical resource transmissions have been initiated by that user at the same virtual location.

In some embodiments, and as shown in block 504, the process flow 500 may include the step of dynamically updating the virtual computing environment avatar based on the at least one historical resource transmission at each of the at least one geolocation coordinate or the at least one entity identifier. For example, and in some embodiments, such a dynamic change may additionally, and/or alternatively, comprise other metadata regarding the avatar such as the pixelation of the avatar as it appears in the virtual computing environment (e.g., the greater the historical resource transmissions, the greater pixels and more clear the image of the virtual computing environment avatar), the facial expressions of the virtual computing avatar may dynamically change (the facial expression may appear happier for at locations with greater historical resource transmissions, or sadder with fewer resource transmissions), and/or the like. As used herein, the phrase “greater resource transmissions” is understood to comprise the instances of the greater number of individual historical resource transmissions collected for each geolocation coordinate and/or entity identifier, and/or the greater the overall combination of historical resource transmissions collected for each geolocation coordinate and/or entity identifier (e.g., an overall historical resource transmission amount over the resource transmission period). Similarly, the phrase “fewer resource transmissions” is understood to comprise the instances where the number of individual historical resource transmissions collected for each geolocation coordinate and/or entity identifier which may be low in number or value, and/or the overall combination of historical resource transmissions collected for each geolocation coordinate and/or entity identifier which may be low in number or value.

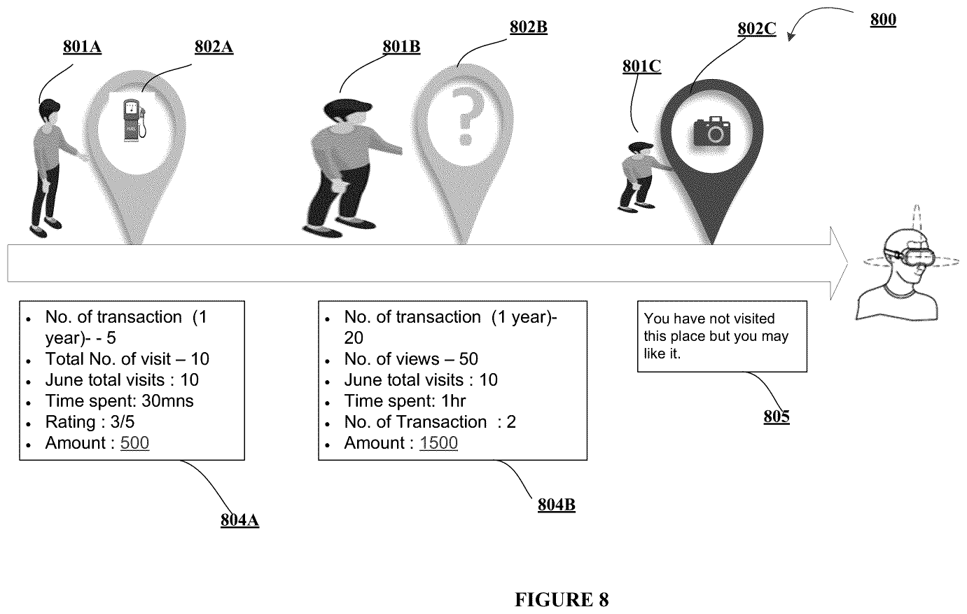

In some embodiments, the virtual computing environment avatar dynamically changes comprises a dynamic change to a size of the virtual computing environment avatar and/or a clothing component of the virtual computing environment avatar. For example, and in some such embodiments, the size of the avatar may change dynamically (e.g., get bigger) based on the number of historical resource transmissions that have occurred at the entity/geolocation, and/or based on the total amount of historical resource transmissions, the number of false historical resource transmissions, and/or the like. In some embodiments, the clothing may additionally and/or alternatively change as well in much the same way (e.g., the color of the clothing on the avatar may change based on the amount paid, the number of individual transmissions, and/or the like). Such changes to the avatar may occur dynamically as the avatar moves through the virtual computing environment to different geolocations/entities. Such an example is described in further detail below with respect to FIG. 8.

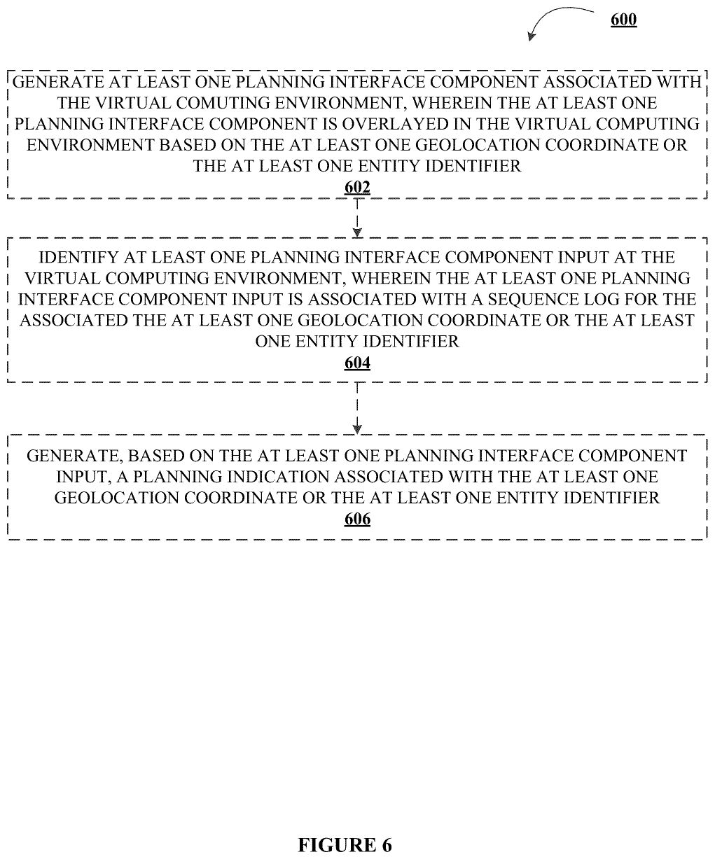

FIG. 6 illustrates a process flow 600 for generating a planning indication, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process flow 600. In some embodiments, an artificial intelligence engine (e.g., such as the AI engine shown in FIG. 2) may perform some or all of the steps of process flow 600.

In some embodiments, and as shown in block 602, the process flow 600 may include the step of generating at least one planning interface component associated with the virtual computing environment, wherein the at least one planning interface component is overlayed in the virtual computing environment based on the at least one geolocation coordinate or the at least one entity identifier. For example, and in some embodiments, the system may generate at least one planning interface component which may comprise data in a data packet, whereby the data in the data packet may be associated with information regarding each virtual location within the virtual computing environment (e.g., such as virtual renderings of merchant locations, storefronts, service-provider locations, and/or the like). In some embodiments, the information in the planning interface component may comprise data regarding historical resource transmissions, false historical resource transmissions, geolocation identifiers, entity identifier and/or names, number of resource transmissions, whether the location is popular, a popularity rating, offers (e.g., current and/or future), and/or the like.

Such a planning interface component may be overlayed over each virtual location within the virtual computing environment and/or only certain virtual locations that the system may have data on (e.g., those that may have opted into the system and its service), and/or the like. Further, and in some embodiments, the planning interface component may comprise at least one input for a user to interact with as they “move” through the virtual computing environment, whereby such an input may request the user's interaction in order to add the geolocation to a sequence log and/or list that the user may want to visit in the real-world. Such an input is described in further detail below.

For instance, and as used herein, the planning interface component may be used to help plan a user's path, resource transmission plan, and/or the like, which may be based on a user's interactions within the virtual computing environment (e.g., as the user interacts within the map of the virtual computing environment), as offers are generated and/or shown to the user that are current and/or occurring soon), then the user may input feedback (i.e., via a planning interface component input) and used to generate a sequence log of places to visit in the real-world that mirrors and/or is similar to the sequence log generated by the system.

In some embodiments, and as shown in block 604, the process flow 600 may include the step of identifying at least one planning interface component input at the virtual computing environment, wherein the at least one planning interface component input is associated with a sequence log for the associated the at least one geolocation coordinate or the at least one entity identifier. For example, the planning interface component input associated with a sequence log may comprise at least one sequence identifiers (such as but not limited to a “first” identifier, a “second” identifier, . . . an nth identifier, and/or the like) for the virtual locations and the associated real-world locations that the user may wish to visit in the particular sequence.

In some embodiments, the system may generate its own sequence based on the order the virtual locations are added by the user within the virtual computing environment. For instance, and as the user “moves” through the virtual computing environment, the planning interface component may be overlayed at each virtual location identified within the virtual computing environment (e.g., near to and/or superimposed on the virtual location of a merchant's location) and based on the inputs received at the planning interface component (e.g., the planning input(s)), the entity identifier and/or geolocation identifier associated with the virtual location may be added to a list of entity identifiers and/or geolocation identifiers that the user has indicated that the user wants to visit. In some embodiments, and based on the planning inputs received and the order with which they are received, the system may add the entity identifiers and/or geolocation identifiers sequentially and in the same order. In some embodiments, and based on the geolocation identifiers, the system may be configured to generate an optimal order and/or plan for visiting the entities and/or geolocations (e.g., such as based on the user having to travel the lowest amount of miles and/or distance, based on operating hours such that only those locations with less operating hours are visited first and/or during their operating hours, and/or the like).

In some embodiments, and as shown in block 606, the process flow 600 may include the step of generating—based on the at least one planning interface component input—a planning indication associated with the at least one geolocation coordinate or the at least one entity identifier. For example, and in some embodiments, the system may generate a planning indication, whereby the planning indication comprises the list of the geolocations and/or entities that the user has indicated in the virtual computing environment as a place of interest to visit. Similar to the disclosure provided above, such a planning indication may be based on the order with which the planning interface components were received and/or based on the system's configuration of an optimal order.

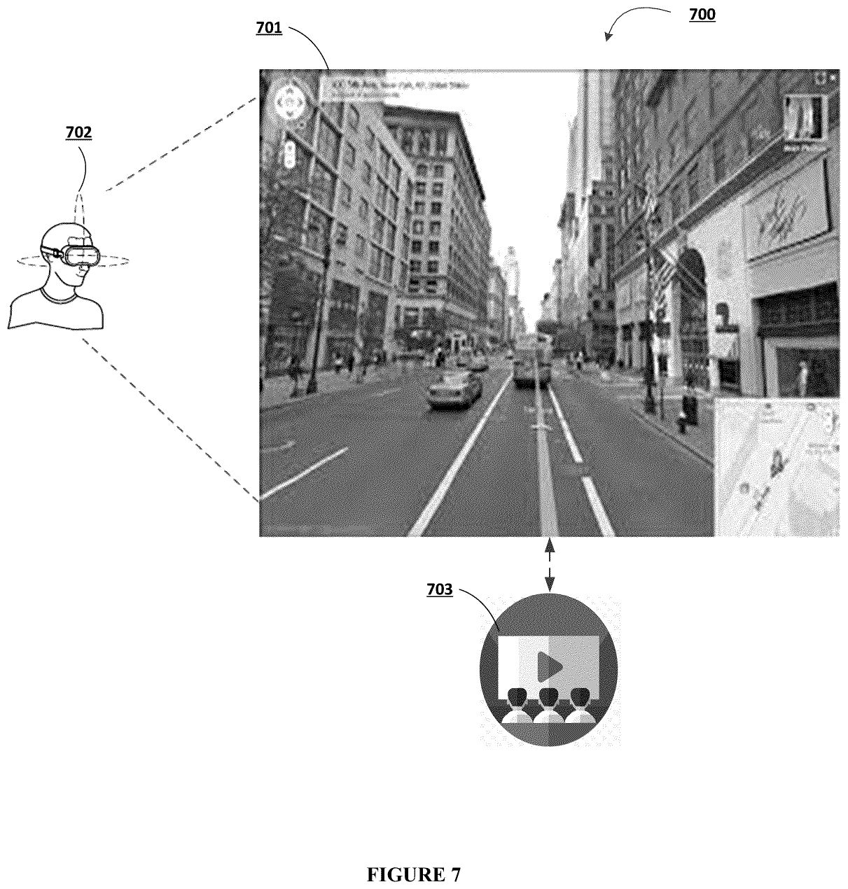

FIG. 7 illustrates an exemplary virtual computing environment 700, in accordance with an embodiment of the disclosure. In some embodiments, a system (e.g., similar to one or more of the systems described herein with respect to FIGS. 1A-1C) may perform one or more of the steps for generating virtual computing environment 700. For example, a system (e.g., the system 130 described herein with respect to FIG. 1A-1C) may perform the steps for generating virtual computing environment 700. In some embodiments, an artificial intelligence engine (e.g., such as the AI engine shown in FIG. 2) may perform some or all of the steps for generating virtual computing environment 700.

As shown in exemplary resource transmission movie 703 and virtual computing environment 701, a virtual computing environment showcasing real-world structures (e.g., real-world buildings, buses, cars, and/or the like) may be shown as digital components in a virtual computing environment similar a real-world environment. Additionally, and as a user moves through the real world and/or the virtual computing environment using a VR headset (much like the one shown as VR headset 702), the view in the virtual computing environment and/or resource transmission movie 703 as the user moves through the real-world environment and/or the virtual computing environment.

As shown here, the virtual computing environment 701 may be based on a virtual computing environment map that is meant to mirror and/or parallel a real-world map, such that as the user moves through the virtual computing environment 701, the images shown to the user match what the user would see in the real-world (e.g., based on a real-world map that also mirrors the virtual computing environment map).

FIG. 8 illustrates an exemplary virtual computing environment avatars 800, in accordance with an embodiment of the disclosure. In some embodiments, a system (e.g., similar to one or more of the systems described herein with respect to FIGS. 1A-1C) may perform one or more of the steps for generating virtual computing environment avatars 800. For example, a system (e.g., the system 130 described herein with respect to FIG. 1A-1C) may perform the steps for generating virtual computing environment avatars 800. In some embodiments, an artificial intelligence engine (e.g., such as the AI engine shown in FIG. 2) may perform some or all of the steps for generating virtual computing environment avatars 800.

For example, and as shown herein, the system may comprise and/or generate at least one virtual computing environment avatar (e.g., virtual computing environment avatar 801A, 801B, 801C, and/or the like), and each of these avatars may comprise similar characteristics (e.g., facial features, hair color, clothing, and/or the like), but other characteristics (e.g., height, width, clothing color, and/or the like) may change dynamically as the virtual computing environment avatar moves through the virtual computing environment and/or resource transmission movie. For instance, and as the virtual computing environment avatar (e.g., 801A, 801B, 801C) moves through the resource transmission movie, the size of the virtual computing environment avatar may change dynamically as the viewer is viewing the resource transmission movie (e.g., using a VR headset) and/or as the historical resource transmissions are shown as true and/or false.

Additionally, and in some embodiments, digital components showing data on the virtual locations (e.g., such as pop-ups 804A, 804B, 805, and/or the like) may show data regarding each virtual location and/or entity identifier that the virtual computing environment avatar may visit. Such data may show the number of historical resource transmissions by the user for a resource transmission period, the total number of visits in the real-world location, the number of visits in the resource transmission period, the total time spent at the real-world location, the overall rating for the real-world location, and the total historical resource transmission amount by the user, and/or the like). In some embodiments, the data may indicate places that the user has not yet visited, but may—based on other geolocations and/or entities visited in the real-world—should be visited by the user. In some embodiments, such data may further comprise offers (e.g., current and/or future) the user may want to use.

In some embodiments, digital components showing the kind of entity and/or geolocation the user visited may be shown (e.g., 802A, 802B, 802C), whereby an icon may be filled in (e.g., a gas tank icon 802A may be used to indicate a gas station was visited by the user and a historical resource transmission occurred). In some embodiments, and where a historical resource transmission needs to be validated, an icon may be used to indicate this to the user (e.g., such as an exclamation mark, a question mark (“?”) like that shown in 802B, and/or the like).

FIG. 9 illustrates an exemplary virtual computing environment 900 based on geolocation coordinates or entity identifiers and comprising virtual computing environment alert interface components, in accordance with an embodiment of the disclosure. In some embodiments, a system (e.g., similar to one or more of the systems described herein with respect to FIGS. 1A-1C) may perform one or more of the steps for generating virtual computing environment 900. For example, a system (e.g., the system 130 described herein with respect to FIG. 1A-1C) may perform the steps for generating virtual computing environment 900. In some embodiments, an artificial intelligence engine (e.g., such as the AI engine shown in FIG. 2) may perform some or all of the steps for generating virtual computing environment 900.

For example, and as shown in exemplary virtual computing environment 900, a plurality of virtual computing environment avatars (901A, 901B, and/or the like) may interact within the virtual computing environment 900 and move through the virtual computing environment to complete each of the processes, activities, and/or the like described herein. In some embodiments, the virtual computing environment may be overlayed a real-world environment, and as the user walks through the real-world environment the virtual computing environment may update to mirror the structures shown in the real-world (e.g., as the user moves from location to location, the same virtual locations and their associated digital components may progress as well). Similarly, and as the user moves through the real-world environment and/or the virtual computing environment, the digital components (e.g., 902) may change and update dynamically to be rendered in the virtual computing environment. For instance, such digital components may comprise pop-ups of indicators showing the data of each virtual location, historical resource transmissions, false historical resource transmissions, planning interface components, planning interface component inputs, warning alert interface components, and/or the like.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent | | |
|---|---|---|---|
| | Application | | |
| Docket Number | Ser. No. | Title | Filed On |
| 15367US1.014033.4810 | To be assigned | SYSTEMS AND METHODS FOR | Concurrently |
| | | GENERATING AN INTERACTIVE 3D | herewith |
| | | ENVIRONMENT USING SPATIAL | |
| | | COMPUTING TO GENERATE | |
| | | HISTORICAL DIGITAL COMPONENTS | |

What is claimed is:

1. A system for generating an interactive 3D environment using spatial computing for validation of data, the system comprising:
a memory device with computer-readable program code stored thereon;
at least one processing device, wherein executing the computer-readable code is configured to cause the at least one processing device to perform the following operations:
identify at least one user account, wherein the at least one user account is associated with at least one resource account;
identify at least one historical resource transmission based on the at least one resource account, wherein the at least one historical resource transmission is associated with at least one geolocation coordinate or at least one entity identifier;
generate a virtual computing environment based on the at least one historical resource transmission and at least one of the geolocation coordinate or the at least one entity identifier; and
generate at least one virtual computing environment alert interface component, wherein the at least one virtual computing environment alert interface component comprises at least one validation indicator associated with each historical resource transmission of the at least one historical resource transmission, and wherein the at least one virtual computing environment alert interface component is overlayed in the virtual computing environment.

2. The system of claim 1, wherein executing the computer-readable code is configured to cause the at least one processing device to perform the following operations:
identify whether the at least one validation indicator comprises a positive input;
generate, based on the identification that the at least one validation indicator comprises the positive input, a warning alert interface component; and
overlay the warning alert interface component on the virtual computing environment at a virtual location associated with the geolocation coordinate or the entity identifier.

3. The system of claim 2, wherein the at least one validation indicator comprising the positive input comprises a dispute claim input in the virtual computing environment.

4. The system of claim 2, wherein the warning alert interface component comprises a real-time value at the virtual location.

5. The system of claim 1, wherein executing the computer-readable code is configured to cause the at least one processing device to perform the following operations:
generate a virtual computing environment avatar based on the user amount, the at least one historical resource transmission; and
dynamically update the virtual computing environment avatar based on the at least one historical resource transmission at each of the at least one geolocation coordinate or the at least one entity identifier.

6. The system of claim 5, wherein the virtual computing environment avatar is dynamically updated based on at least one positive indicator associated with the at least one geolocation coordinate or the at least one entity identifier.

7. The system of claim 1, wherein executing the computer-readable code is configured to cause the at least one processing device to perform the following operations:
generate at least one planning interface component associated with the virtual computing environment, wherein the at least one planning interface component is overlayed in the virtual computing environment based on the at least one geolocation coordinate or the at least one entity identifier;
identify at least one planning interface component input at the virtual computing environment, wherein the at least one planning interface component input is associated with a sequence log for the associated the at least one geolocation coordinate or the at least one entity identifier; and
generate, based on the at least one planning interface component input, a planning indication associated with the at least one geolocation coordinate or the at least one entity identifier.

8. The system of claim 1, wherein the virtual computing environment is generated based on a large video map model (LVMM), and wherein the LVMM is pre-trained on a plurality of videos, a plurality of images, a plurality of visual effects, a plurality geographical coordinates, and a plurality of images or videos associated with each geographical coordinate of the plurality of geographical coordinates.

9. A computer program product for generating an interactive 3D environment using spatial computing for validation of data, wherein the computer program product comprises at least one non-transitory computer-readable medium having computer-readable program code portions embodied therein, the computer-readable program code portions which when executed by a processing device are configured to cause the processor to perform the following operations:
identify at least one user account, wherein the at least one user account is associated with at least one resource account;
identify at least one historical resource transmission based on the at least one resource account, wherein the at least one historical resource transmission is associated with at least one geolocation coordinate or at least one entity identifier;
generate a virtual computing environment based on the at least one historical resource transmission and at least one of the geolocation coordinate or the at least one entity identifier; and
generate at least one virtual computing environment alert interface component, wherein the at least one virtual computing environment alert interface component comprises at least one validation indicator associated with each historical resource transmission of the at least one historical resource transmission, and wherein the at least one virtual computing environment alert interface component is overlayed in the virtual computing environment.

10. The computer program product of claim 9, wherein the computer-readable program code portions which when executed by a processing device are configured to cause the processor to perform the following operations:
identify whether the at least one validation indicator comprises a positive input;
generate, based on the identification that the at least one validation indicator comprises the positive input, a warning alert interface component; and
overlay the warning alert interface component on the virtual computing environment at a virtual location associated with the geolocation coordinate or the entity identifier.

11. The computer program product of claim 10, wherein the at least one validation indicator comprising the positive input comprises a dispute claim input in the virtual computing environment.

12. The computer program product of claim 10, wherein the warning alert interface component comprises a real-time value at the virtual location.

13. The computer program product of claim 9, wherein the computer-readable program code portions which when executed by a processing device are configured to cause the processor to perform the following operations:
generate a virtual computing environment avatar based on the user amount, the at least one historical resource transmission; and
dynamically update the virtual computing environment avatar based on the at least one historical resource transmission at each of the at least one geolocation coordinate or the at least one entity identifier.

14. The computer program product of claim 13, wherein the virtual computing environment avatar is dynamically updated based on at least one positive indicator associated with the at least one geolocation coordinate or the at least one entity identifier.

15. A computer implemented method for generating an interactive 3D environment using spatial computing for validation of data, the computer implemented method comprising:
identifying at least one user account, wherein the at least one user account is associated with at least one resource account;
identifying at least one historical resource transmission based on the at least one resource account, wherein the at least one historical resource transmission is associated with at least one geolocation coordinate or at least one entity identifier;
generating a virtual computing environment based on the at least one historical resource transmission and at least one of the geolocation coordinate or the at least one entity identifier; and
generating at least one virtual computing environment alert interface component, wherein the at least one virtual computing environment alert interface component comprises at least one validation indicator associated with each historical resource transmission of the at least one historical resource transmission, and wherein the at least one virtual computing environment alert interface component is overlayed in the virtual computing environment.

16. The computer implemented method of claim 15, further comprising:
identifying whether the at least one validation indicator comprises a positive input;
generating, based on the identification that the at least one validation indicator comprises the positive input, a warning alert interface component; and
overlaying the warning alert interface component on the virtual computing environment at a virtual location associated with the geolocation coordinate or the entity identifier.

17. The computer implemented method of claim 16, wherein the at least one validation indicator comprising the positive input comprises a dispute claim input in the virtual computing environment.

18. The computer implemented method of claim 16, wherein the warning alert interface component comprises a real-time value at the virtual location.

19. The computer implemented method of claim 15, further comprising:
generating a virtual computing environment avatar based on the user amount, the at least one historical resource transmission; and
dynamically updating the virtual computing environment avatar based on the at least one historical resource transmission at each of the at least one geolocation coordinate or the at least one entity identifier.

20. The computer implemented method of claim 19, wherein the virtual computing environment avatar is dynamically updated based on at least one positive indicator associated with the at least one geolocation coordinate or the at least one entity identifier.
